(19) United States
(12) Patent Application Publication
(10) Pub. No.: US 2025/0116516 A1
(43) Pub. Date: Apr. 10, 2025

(54) Alignment Verification And Distance Measuring Device And Method Of Use

(71) Applicant: Alan Seiter, Royse City, TX (US)

(72) Inventor: Alan Seiter, Royse City, TX (US)

(21) Appl. No.: 18/377,200

(22) Filed: Oct. 5, 2023

(51) Int. Cl. G01C 15/00

(52) U.S. Cl. CPC G01C 15/006

(57) ABSTRACT

An alignment verification and distance measuring device for fitting pipes includes a laser telemeter and a pair of couplers. The laser telemeter comprises a laser projector, which selectively emits a continuous laser beam and a laser pulse, and a sensor to detect the continuous laser beam and the laser pulse. Each coupler is removably couplable to a respective one of the laser projector and the sensor and is removably couplable to a respective pipe of a pair of pipes so that an end of one of the pipes is axially fitted with the laser projector and an end of the other of the pipes is axially fitted with the sensor. The laser telemeter facilitates alignment of the pipes by detection of the continuous laser beam by the sensor and determination of a distance between the ends of the pipes based on a time of flight of the laser pulse.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to pipe fitting aids and more particularly pertains to a new pipe fitting aid for fitting pipes. Proper alignment of pipes of a pair of pipes and determination of a distance between the ends of the pipes are difficult but routine tasks that must be performed by pipe fitters. A device that can perform both alignment and distance measurement functions would be beneficial in facilitating quick and accurate completion of these tasks.

### (2) Description of Related Art Including Information Disclosed Under 37 CFR 1.97 and 1.98

The prior art relates to pipe fitting aids, which may comprise pipe mountable lasers for aligning pipes and for marking positions for hole drilling. What is lacking in the prior art is a pipe fitting aid comprising a laser projector and a sensor, which allow for both alignment of pipes of a pair of pipes and determination of a distance between ends of the pipes.

### (h) BRIEF SUMMARY OF THE INVENTION

An embodiment of the disclosure meets the needs presented above by generally comprising a laser telemeter and a pair of couplers. The laser telemeter comprises a laser projector, which selectively emits a continuous laser beam and a laser pulse, and a sensor to detect the continuous laser beam and the laser pulse. Each coupler is removably couplable to a respective one of the laser projector and the sensor and is configured to removably couple to a respective pipe of a pair of pipes so that an end of one of the pipes is axially fitted with the laser projector and an end of the other of the pipes is axially fitted with the sensor. The laser telemeter is configured to facilitate alignment of the pipes by detection of the continuous laser beam by the sensor. The laser telemeter also is configured to determine a distance between the ends of the pipes based on a time of flight of the laser pulse.

Another embodiment of the disclosure includes an alignment verification and distance measuring kit for fitting pipes. The kit comprises a laser telemeter, as described in the disclosure above, and a plurality of gaskets. The pair of couplers of the kit comprises a plurality of tubes. The plurality of tubes of the kit comprises pairs of tubes. Each tube of a respective pair of tubes has an equivalent outer diameter. The tubes of the pair of tube thus are removably couplable to a pair of pipes having equivalent interior diameters by insertion of the tubes into the ends of the pipes and to the laser projector and the sensor. The gaskets stabilize the laser projector and the sensor within the tubes. The kit also may include the programming code, which enables electronic device of a user to receive confirmation of alignment and a determination of the distance between the ends of the pipes.

Yet another embodiment of the disclosure includes a method of aligning and measuring a distance between ends of a pair of pipes. The method entails provision of the alignment verification and distance measuring kit, according to the disclosure above. Steps of the method include selecting a pair of tubes having outer diameters complementary to the interior diameters of the ends of the pipes, inserting the laser projector into one of the tubes, inserting the sensor into the other of the tubes, inserting gaskets singly into each of the recesses, inserting the tubes singly into the ends of the pipes, adjusting the pipes so that the continuous laser beam is detected by the sensor, and determining a distance between the ends of the pipes based on a time of flight of a laser pulse.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a kit view of an alignment verification and distance measuring device according to an embodiment of the disclosure.

FIG. 2 is a front isometric perspective view of an embodiment of the disclosure.

FIG. 3 is a rear isometric perspective view of an embodiment of the disclosure.

FIG. 4 is a side view of an embodiment of the disclosure.

FIG. 5 is a cross-sectional view of an embodiment of the disclosure.

FIG. 6 is a cross-sectional view of an embodiment of the disclosure.

FIG. 7 is an exploded view of an embodiment of the disclosure.

FIG. 8 is an in-use view of an embodiment of the disclosure.

FIG. 9 is an in-use view of an embodiment of the disclosure.

FIG. 10 is a flow diagram for a method utilizing an embodiment of the disclosure.

### (j) DETAILED DESCRIPTION OF THE INVENTION

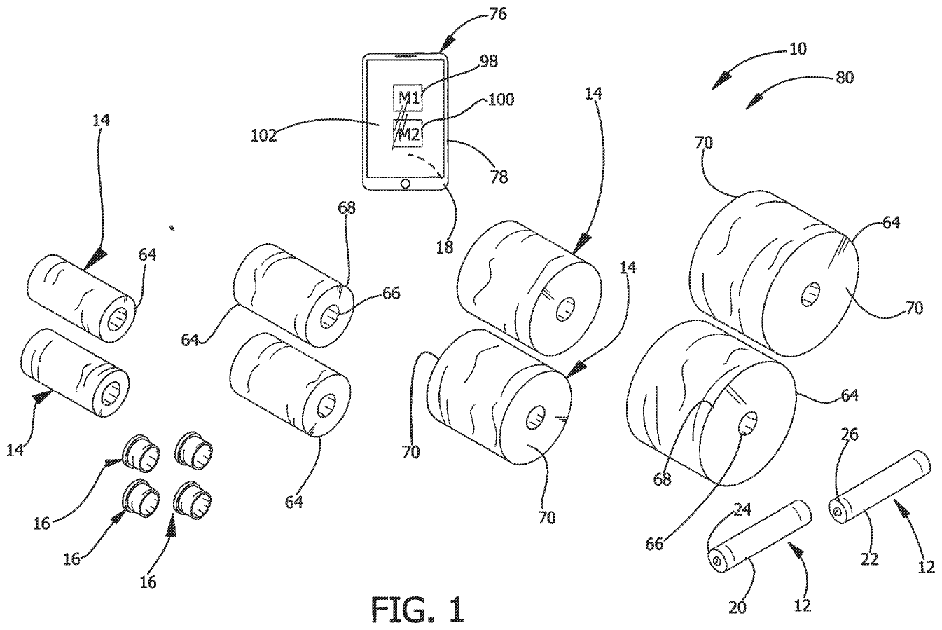

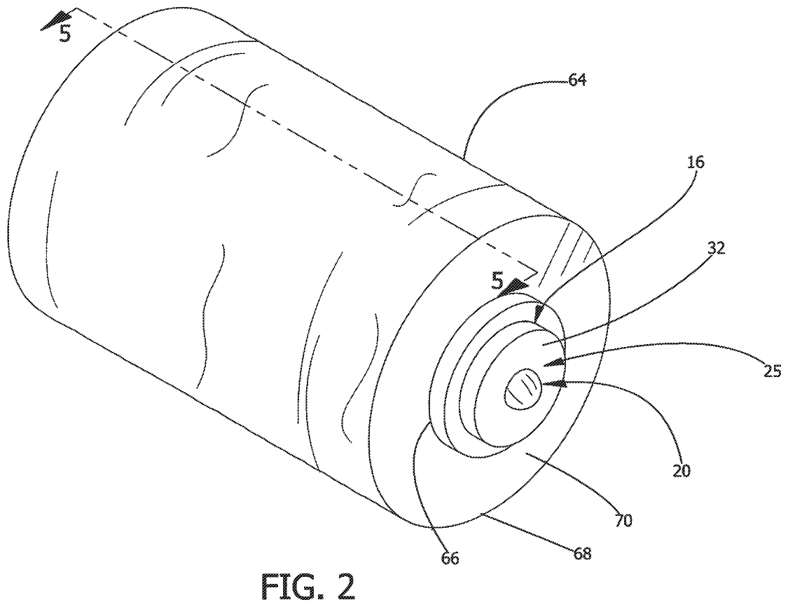

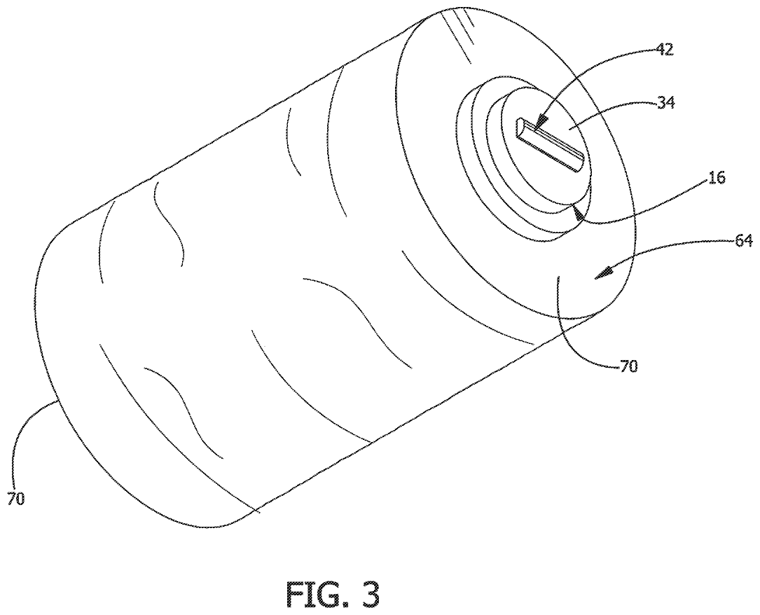

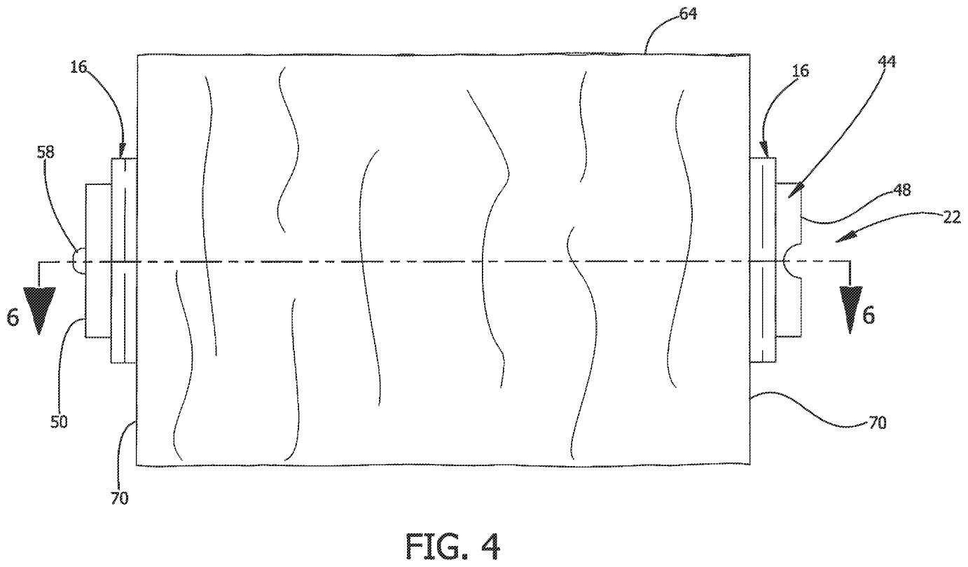

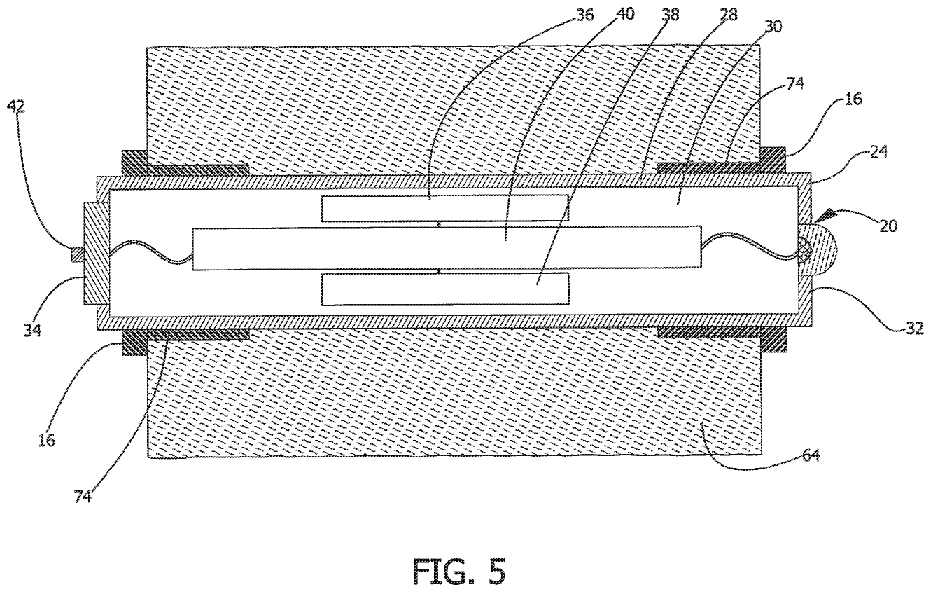

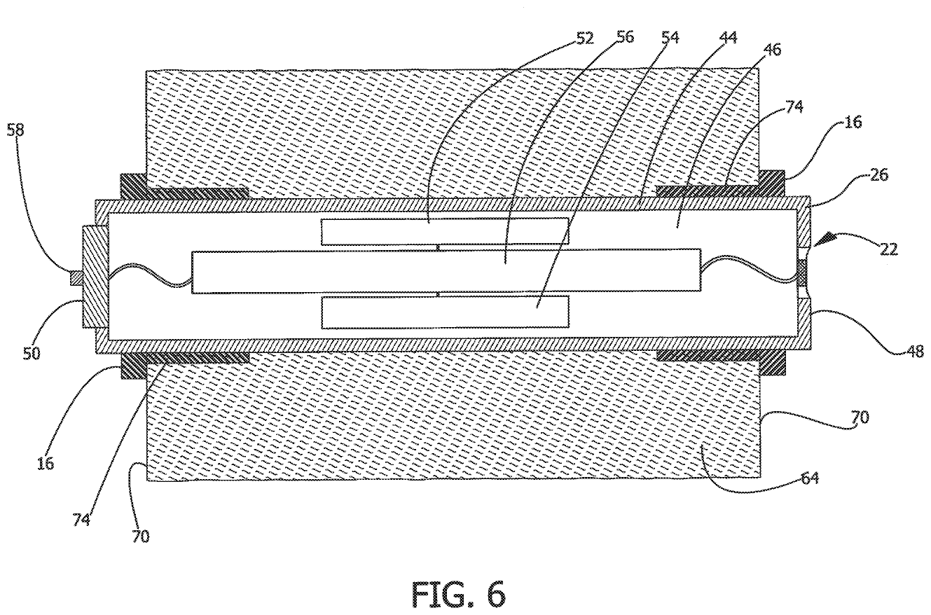

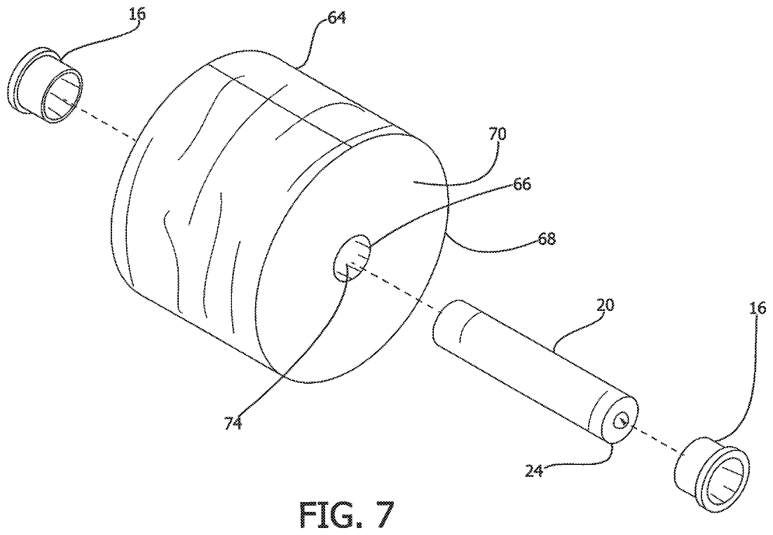

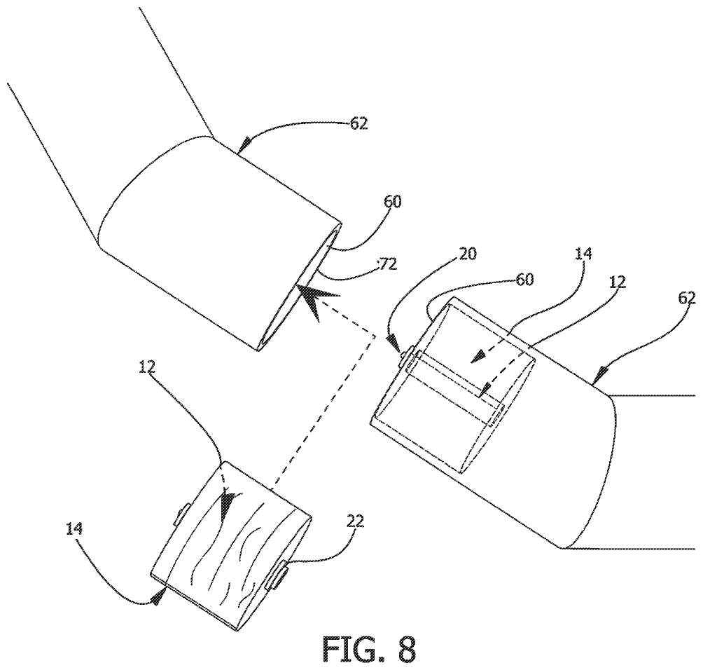

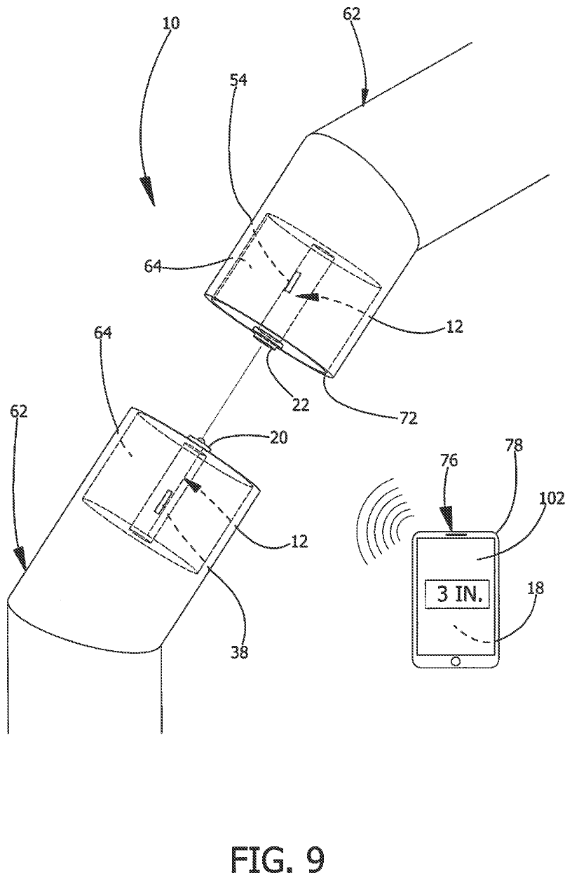

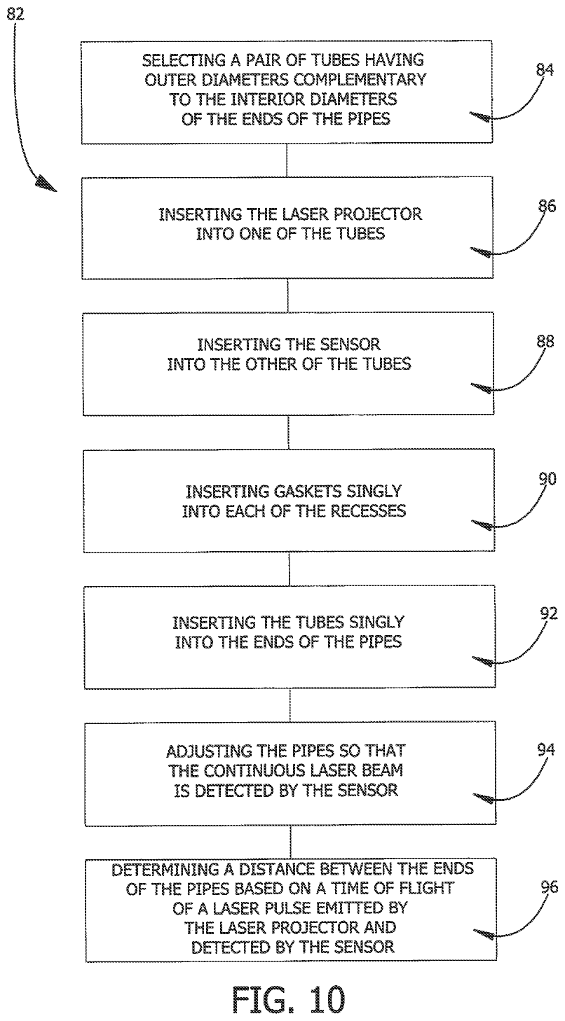

With reference now to the drawings, and in particular to FIGS. 1 through 10 thereof, a new pipe fitting aid embodying the principles and concepts of an embodiment of the disclosure and generally designated by the reference numeral 10 will be described.

As best illustrated in FIGS. 1 through 10, the alignment verification and distance measuring device 10 generally comprises a laser telemeter 12, a pair of couplers 14, a plurality of gaskets 16, and programming code 18. The laser telemeter 12 comprises a laser projector 20, which selectively emits a continuous laser beam and a laser pulse, and a sensor 22 to detect the continuous laser beam and the laser pulse. The laser projector 20 and the sensor 22 each have an exterior diameter (24 and 26, respectively), with the exterior diameter 26 of the sensor 22 being equivalent to the exterior diameter 24 of the laser projector 20. The laser projector 20 and the sensor 22 typically are substantially cylindrical but may be alternatively shaped, such as, but not limited to, cuboid, elliptic cylindrical, or the like.

The laser projector 20 comprises a first housing 28, which defines an interior space 30 and which has a first endpoint 32 and a second endpoint 34. The continuous laser beam and the laser pulse are emitted from the first endpoint 32. A first battery 36, a first transceiver 38, and a first microprocessor 40 are attached to the first housing 28 and are positioned in the interior space 30. The first microprocessor 40 is operationally engaged to the first battery 36 and the first transceiver 38. A first switch 42 is attached to the second endpoint 34 of the first housing 28 and is operationally engaged to the first microprocessor 40 to selectively power the laser projector 20.

The sensor 22 comprises a second housing 44, which defines an internal space 46 and which has a first end 48 and a second end 50. The sensor 22 detects laser light impinging on the first end 48. A second battery 52, a second transceiver 54, and a second microprocessor 56 are attached to the second housing 44 and are positioned in the internal space 46. The second microprocessor 56 is operationally engaged to the second battery 52 and the second transceiver 54 so that the second microprocessor 56 is communicatively engaged to the first microprocessor 40. A second switch 58 is attached to the second end 50 of the second housing 44 and is operationally engaged to the second microprocessor 56 to selectively power the sensor 22. The first microprocessor 40 and the second microprocessor 56 are programmed to assess when the sensor 22 is receiving the continuous laser beam emitted by the laser projector 20, to determine alignment, and to calculate the distance between the laser projector 20 and the sensor 22 based on the time of flight for the laser pulse.

The present invention also anticipates the laser projector 20 and the sensor 22 comprising a unitary device attachable to an end 60 of one pipe 62 of a pair of pipes 62 and a reflector (not shown) being configured to attach to an end 60 of the other pipe 62. An axially positioned mark, such as small circle, on the reflector would be used to confirm alignment and the time of flight of the laser pulse would be a round trip time between the ends 60 of the pipes 62.

Each coupler 14 is removably couplable to a respective one of the laser projector 20 and the sensor 22 and is configured to removably couple to a respective pipe 62 of the pair of pipes 62 so that an end 60 of one of the pipes 62 is axially fitted with the laser projector 20 and an end 60 of the other of the pipes 62 is axially fitted with the sensor 22. The laser telemeter 12 thus is configured to facilitate alignment of the pipes 62 by detection of the continuous laser beam by the sensor 22. The laser telemeter 12 also is configured to determine a distance between the ends 60 of the pipes 62 based on the time of flight of the laser pulse. Pipe 62, in the context of this disclosure, should be interpreted to mean any tubular conduit which is joinable to another tubular conduit, such as, but not limited to, metal piping, plastic piping, concrete piping, or the like, and having any cross-sectional profile, such as, but not limited to, circular, oval, square, or the like.

In one example, as is shown in FIG. 1, each coupler 14 comprises a plurality of tubes 64, each having an inner diameter 66, an outer diameter 68, and opposed ends 70. The tubes 64 typically would comprise foamed elastomer, silicone, or the like, so that the tubes 64 are semirigid. The inner diameter 66 is complementary to the exterior diameters 26 and 24 of the sensor 22 and the laser projector 20, respectively, so that a respective one of the sensor 22 and the laser projector 20 is removably couplable to each tube 64 by insertion of the respective one of the sensor 22 and the laser projector 20 into a respective opposed end 70 the tube 64. The outer diameter 68 of each tube 64 has a respective size so that the plurality of tubes 64 comprises tubes 64 having outer diameters 68 of a variety of sizes for selective insertion into pipes 62 having a variety of complementary interior diameters 72.

Each opposed end 70 of each tube 64 has a recess 74 extending axially into the opposed end 70 so that the inner diameter 66 of the tube 64 is larger adjacent to each opposed end 70. Each gasket 16 is selectively insertable into a respective recess 74 and around a respective one of the laser projector 20 and the sensor 22 positioned in a respective tube 64 so that each recess 74 of each tube 64 is occupied by a respective gasket 16 to stabilize the laser projector 20 and the sensor 22 withing their respective tubes 64. The gaskets 16 comprise rubber, silicone, elastomer, or the like.

The programming code 18 is selectively positionable on an electronic device 76, such as a smartphone 78, of a user. The programming code 18 enables the electronic device 76 for wireless communication with the first microprocessor 40 and the second microprocessor 56 to receive confirmation of the sensor 22 receiving the continuous laser beam and the distance measurement between the ends 60 of the pipes 62, as determined by the time of flight of the laser pulse. The programming code 18 also enables the electronic device 76 to selectively actuate the laser projector 20 in a first mode and a second mode by touching a first icon 98 and a second icon 100, respectively, on a screen 102 of the electronic device 76. In the first mode, the laser projector emits 20 the continuous laser beam to align the pipes 62 and in the second mode the laser projector 20 emits a laser pulse to determine the distance between the ends 60 of the pipes 62.

The present invention anticipates an alignment verification and distance measuring kit 80 for fitting pipes 62, as is shown in FIG. 1. The kit 80 comprises a laser telemeter 12, a plurality of tubes 64, and a plurality of gaskets 16, as described in the specification above. The plurality of tubes 64 of the kit 80 comprises pairs of tubes 64. Each tube 64 of a respective pair of tubes 64 has an equivalent outer diameter 68. The tubes 64 of the pair of tube 64 thus are removably couplable to a pair of pipes 62 having equivalent interior diameters 72 by insertion of the tubes 64 into the ends 60 of the pipes 62. The kit 80 also may include the programming code 18, as described above, which is selectively positionable on an electronic device 76 of a user.

In use, the alignment verification and distance measuring kit 80 enables a method of aligning and measuring a distance between ends of a pair of pipes 82. The method 82 entails provision of the alignment verification and distance measuring kit 80, according to the specification above. A first step 84 of the method 82 is selecting a pair of tubes 64 having outer diameters 68 complementary to the interior diameters 72 of the ends 60 of the pipes 62. A second step 86 of the method 82 is inserting the laser projector 20 into one of the tubes 64. A third step 88 of the method 82 is inserting the sensor 22 into the other of the tubes 64. A fourth step 90 of the method 82 is inserting gaskets 16 singly into each of the recesses 74. A fifth step 92 of the method 82 is inserting the tubes 64 singly into the ends 60 of the pipes 62. A sixth step 94 of the method 82 is adjusting the pipes 62 so that the continuous laser beam is detected by the sensor 22. A seventh step 96 of the method 82 is determining a distance between the ends 60 of the pipes 62 based on a time of flight of a laser pulse emitted by the laser projector 20 and detected by the sensor 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An alignment verification and distance measuring device comprising:
a laser telemeter comprising:
a laser projector for selectively emitting a continuous laser beam and a laser pulse; and
a sensor for detecting the continuous laser beam and the laser pulse;
a pair of couplers, each coupler being removably couplable to a respective one of the laser projector and the sensor and being configured to removably couple to a respective pipe of a pair of pipes, such that an end of one of the pipes is axially fitted with the laser projector and an end of the other of the pipes is axially fitted with the sensor; and
wherein the laser telemeter is configured to facilitate alignment of the pipes by detection of the continuous laser beam by the sensor and wherein the laser telemeter is configured to determine a distance between the ends of the pipes based on a time of flight of the laser pulse.

2. The alignment verification and distance measuring device of claim 1, wherein:
the laser projector comprises:
a first housing defining an interior space and having a first endpoint and a second endpoint, the continuous laser beam and the laser pulse being emitted from the first endpoint;
a first battery attached to the first housing and positioned in the interior space;
a first transceiver attached to the first housing and positioned in the interior space;
a first microprocessor attached to the first housing and positioned in the interior space, the first microprocessor being operationally engaged to the first battery and the first transceiver; and
a first switch attached to the second endpoint of the first housing and being operationally engaged to the first microprocessor for selectively powering the laser projector;
the sensor comprises:
a second housing defining an internal space and having a first end and a second end, the sensor detecting laser light impinging on the first end;
a second battery attached to the second housing and positioned in the internal space;
a second transceiver attached to the second housing and positioned in the internal space;
a second microprocessor attached to the second housing and positioned in the internal space, the second microprocessor being operationally engaged to the second battery and the second transceiver, such that the second microprocessor is communicatively engaged to the first microprocessor; and
a second switch attached to the second end of the second housing and being operationally engaged to the second microprocessor for selectively powering the sensor; and
the first microprocessor and the second microprocessor are programmed to assess when the sensor is receiving the continuous laser beam emitted by the laser projector and to calculate the distance between the laser projector and the sensor based on the time of flight for the laser pulse.

3. The alignment verification and distance measuring device of claim 1, wherein:
the laser projector and the sensor each have an exterior diameter, the exterior diameter of the sensor being equivalent to the exterior diameter of the laser projector; and
each coupler of the pair of couplers comprises a plurality of tubes, each tube of the plurality of tubes having an inner diameter, an outer diameter, and opposed ends, the inner diameter being complementary to the exterior diameters of the sensor and the laser projector, such that a respective one of the sensor and the laser projector is removably couplable to each tube of the plurality of tubes by insertion of the respective one of the sensor and the laser projector into a respective opposed end the tube, the outer diameter of each tube having a respective size, such that the plurality of tubes comprises tubes having outer diameters of a variety of sizes for selective insertion into pipes having a variety of complementary interior diameters.

4. The alignment verification and distance measuring device of claim 3, wherein the tubes of the plurality of tubes comprise foamed elastomer, such that the tubes are semirigid.

5. The alignment verification and distance measuring device of claim 3, wherein the laser projector and the sensor are substantially cylindrical.

6. The alignment verification and distance measuring device of claim 3, further including:
each opposed end of each tube of the plurality of tubes having a recess extending axially into the opposed end, such that the inner diameter of the tube is larger adjacent to each opposed end; and
a plurality of gaskets, each gasket of the plurality of gaskets being selectively insertable into a respective recess and around a respective one of the laser projector and the sensor positioned in a respective tube, such that each recess of each tube is occupied by a respective gasket for stabilizing the laser projector and the sensor within respective tubes.

7. The alignment verification and distance measuring device of claim 6, wherein the gaskets of the plurality of gaskets comprising rubber, silicone, or elastomer.

8. The alignment verification and distance measuring device of claim 2, further including programming code selectively positionable on an electronic device of a user enabling the electronic device for wireless communication with the first microprocessor and the second microprocessor for receiving confirmation of the sensor receiving the continuous laser beam and the distance measurement between the ends of the pipes, the programming code enabling the electronic device for selectively actuating the laser projector in a first mode, wherein the laser projector emits a continuous laser beam, and a second mode, wherein the laser projector emits a laser pulse.

9. The alignment verification and distance measuring device of claim 1, further including:
the laser projector being substantially cylindrical, the laser projector having an exterior diameter, the laser projector comprising:
a first housing defining an interior space and having a first endpoint and a second endpoint, the continuous laser beam and the laser pulse being emitted from the first endpoint;
a first battery attached to the first housing and positioned in the interior space;
a first transceiver attached to the first housing and positioned in the interior space;
a first microprocessor attached to the first housing and positioned in the interior space, the first microprocessor being operationally engaged to the first battery and the first transceiver; and
a first switch attached to the second endpoint of the first housing and being operationally engaged to the first microprocessor for selectively powering the laser projector;
the sensor being substantially cylindrical, the sensor having an exterior diameter, the exterior diameter of the sensor being equivalent to the exterior diameter of the laser projector, the sensor comprising:
a second housing defining an internal space and having a first end and a second end, the sensor detecting laser light impinging on the first end;
a second battery attached to the second housing and positioned in the internal space;
a second transceiver attached to the second housing and positioned in the internal space;
a second microprocessor attached to the second housing and positioned in the internal space, the second microprocessor being operationally engaged to the second battery and the second transceiver, such that the second microprocessor is communicatively engaged to the first microprocessor; and
a second switch attached to the second end of the second housing and being operationally engaged to the second microprocessor for selectively powering the sensor;
the first microprocessor and the second microprocessor being programmed to assess when the sensor is receiving the continuous laser beam emitted by the laser projector and to calculate the distance between the laser projector and the sensor based on the time of flight for the laser pulse;
each coupler of the pair of couplers comprising a plurality of tubes, each tube of the plurality of tubes having an inner diameter, an outer diameter, and opposed ends, the inner diameter being complementary to the exterior diameters of the sensor and the laser projector, such that a respective one of the sensor and the laser projector is removably couplable to each tube of the plurality of tubes by insertion of the respective one of the sensor and the laser projector into a respective opposed end the tube, the outer diameter of each tube having a respective size, such that the plurality of tubes comprises tubes having outer diameters of a variety of sizes for selective insertion into pipes having a variety of complementary interior diameters, each opposed end of each tube of the plurality of tubes having a recess extending axially into the opposed end, such that the inner diameter of the tube is larger adjacent to each opposed end, the tubes of the plurality of tubes comprising foamed elastomer, such that the tubes are semirigid;
a plurality of gaskets, each gasket of the plurality of gaskets being selectively insertable into a respective recess and around a respective one of the laser projector and the sensor positioned in a respective tube, such that each recess of each tube is occupied by a respective gasket for stabilizing the laser projector and the sensor within respective tubes, the gaskets of the plurality of gaskets comprising rubber, silicone, or elastomer; and
programming code selectively positionable on an electronic device of a user enabling the electronic device for wireless communication with the first microprocessor and the second microprocessor for receiving confirmation of the sensor receiving the continuous laser beam and the distance measurement between the ends of the pipes, the programming code enabling the electronic device for selectively actuating the laser projector in a first mode, wherein the laser projector emits a continuous laser beam, and a second mode, wherein the laser projector emits a laser pulse.

10. An alignment verification and distance measuring kit for fitting pipes comprising:
a laser telemeter comprising:
a laser projector for selectively emitting a continuous laser beam and a laser pulse, the laser projector having an exterior diameter; and
a sensor for detecting the continuous laser beam and the laser pulse, the sensor having an exterior diameter, the exterior diameter of the sensor being equivalent to the exterior diameter of the laser projector;
a plurality of tubes, each tube of the plurality of tubes having an inner diameter, an outer diameter, and opposed ends, the inner diameter being complementary to the exterior diameters of the sensor and the laser projector, such that a respective one of the sensor and the laser projector is removably couplable to each tube of the plurality of tubes by insertion of the respective one of the sensor and the laser projector into a respective opposed end the tube, the outer diameter of each tube having a respective size, such that the plurality of tubes comprises tubes having outer diameters of a variety of sizes for selective insertion into pipes having a variety of complementary interior diameters, the plurality of tubes comprising pairs of tubes, wherein each tube of a respective pair of tubes has an equivalent outer diameter, such that the tubes of the pair of tubes are removably couplable to a pair of pipes by insertion of the tubes into ends of the pipes, such that an end of one of the pipes is axially fitted with the laser projector and an end of the other of the pipes is axially fitted with the sensor, each opposed end of each tube of the plurality of tubes having a recess extending axially into the opposed end, such that the inner diameter of the tube is larger adjacent to each opposed end;
a plurality of gaskets, each gasket of the plurality of gaskets being selectively insertable into a respective recess and around a respective one of the laser projector and the sensor positioned in a respective tube, such that each recess of each tube is occupied by a respective gasket for stabilizing the laser projector and the sensor within respective tubes; and
wherein the laser telemeter is configured to facilitate alignment of the pipes by detection of the continuous laser beam by the sensor and wherein the laser telemeter is configured to determine a distance between the ends of the pipes based on a time of flight of the laser pulse.

11. The kit of claim 10, further including:
the laser projector comprising:
a first housing defining an interior space and having a first endpoint and a second endpoint, the continuous laser beam and the laser pulse being emitted from the first endpoint;
a first battery attached to the first housing and positioned in the interior space;
a first transceiver attached to the first housing and positioned in the interior space;
a first microprocessor attached to the first housing and positioned in the interior space, the first microprocessor being operationally engaged to the first battery and the first transceiver; and
a first switch attached to the second endpoint of the first housing and being operationally engaged to the first microprocessor for selectively powering the laser projector;
the sensor comprising:
a second housing defining an internal space and having a first end and a second end, the sensor detecting laser light impinging on the first end;
a second battery attached to the second housing and positioned in the internal space;
a second transceiver attached to the second housing and positioned in the internal space;
a second microprocessor attached to the second housing and positioned in the internal space, the second microprocessor being operationally engaged to the second battery and the second transceiver, such that the second microprocessor is communicatively engaged to the first microprocessor; and
a second switch attached to the second end of the second housing and being operationally engaged to the second microprocessor for selectively powering the sensor; and
the first microprocessor and the second microprocessor being programmed to assess when the sensor is receiving the continuous laser beam emitted by the laser projector and to calculate the distance between the laser projector and the sensor based on the time of flight for the laser pulse.

12. The kit of claim 11, further including programming code selectively positionable on an electronic device of a user enabling the electronic device for wireless communication with the first microprocessor and the second microprocessor for receiving confirmation of the sensor receiving the continuous laser beam and the distance measurement between the ends of the pipes, the programming code enabling the electronic device for selectively actuating the laser projector in a first mode, wherein the laser projector emits a continuous laser beam, and a second mode, wherein the laser projector emits a laser pulse.

13. The kit of claim 10, wherein the tubes of the plurality of tubes comprise foamed elastomer, such that the tubes are semirigid.

14. The kit of claim 10, wherein the laser projector and the sensor are substantially cylindrical.

15. The kit of claim 10, wherein the gaskets of the plurality of gaskets comprise rubber, silicone, or elastomer.

16. A method of aligning and measuring a distance between ends of a pair of pipes, the method comprising providing the alignment verification and distance measuring kit of claim 10; and
selecting a pair of tubes having outer diameters complementary to the interior diameters of the ends of the pipes;
inserting the laser projector into one of the tubes;
inserting the sensor into the other of the tubes;
inserting gaskets singly into each of the recesses;
inserting the tubes singly into the ends of the pipes;
adjusting the pipes so that the continuous laser beam is detected by the sensor; and
determining a distance between the ends of the pipes based on a time of flight of a laser pulse emitted by the laser projector and detected by the sensor.

17. The method of claim 16, further including:
the laser projector comprising:
a first housing defining an interior space and having a first endpoint and a second endpoint, the continuous laser beam and the laser pulse being emitted from the first endpoint;
a first battery attached to the first housing and positioned in the interior space;
a first transceiver attached to the first housing and positioned in the interior space;
a first microprocessor attached to the first housing and positioned in the interior space, the first microprocessor being operationally engaged to the first battery and the first transceiver; and
a first switch attached to the second endpoint of the first housing and being operationally engaged to the first microprocessor for selectively powering the laser projector;
the sensor comprising:
a second housing defining an internal space and having a first end and a second end, the sensor detecting laser light impinging on the first end;
a second battery attached to the second housing and positioned in the internal space;
a second transceiver attached to the second housing and positioned in the internal space;
a second microprocessor attached to the second housing and positioned in the internal space, the second microprocessor being operationally engaged to the second battery and the second transceiver, such that the second microprocessor is communicatively engaged to the first microprocessor; and
a second switch attached to the second end of the second housing and being operationally engaged to the second microprocessor for selectively powering the sensor;
the method including an additional step of actuating the first switch and the second switch prior to inserting the tubes into the pipes;
the first microprocessor and the second microprocessor being programmed to assess when the sensor is receiving the continuous laser beam emitted by the laser projector and to calculate the distance between the laser projector and the sensor based on the time of flight for the laser pulse;
programming code selectively positionable on an electronic device of a user enabling the electronic device for wireless communication with the first microprocessor and the second microprocessor for receiving confirmation of the sensor receiving the continuous laser beam and the distance measurement between the ends of the pipes, the programming code enabling the electronic device for selectively actuating the laser projector in a first mode, wherein the laser projector emits a continuous laser beam, and a second mode, wherein the laser projector emits a laser pulse;
the method including the additional step of touching a first icon on a screen of the electronic device to actuate the laser projector in the first mode to align the pipes; and
the method including the additional step of touching a second icon on the screen of the electronic device to actuate the laser projector in the second mode to determine the distance between the ends of the pipes.
